(19) United States
(12) Patent Application Publication
(10) Pub. No.: US 2020/0030771 A1
(43) Pub. Date: Jan. 30, 2020

(54) RADIONUCLIDE ADSORBENT, METHOD FOR PREPARING THE SAME AND METHOD FOR REMOVING RADIONUCLIDE USING THE SAME

(71) Applicant: KOREA ATOMIC ENERGY RESEARCH INSTITUTE, Daejeon (KR)

(72) Inventors: Hee-Man YANG, Daejeon (KR); Min Kee CHOI, Daejeon (KR); Eun Hye HAN, Daejeon (KR); In Ho YOON, Daejeon (KR); Il Gook KIM, Daejeon (KR); Chan Woo PARK, Uiwang-si (KR); Kune Woo LEE, Daejeon (KR)

(21) Appl. No.: 16/523,461

(22) Filed: Jul. 26, 2019

(30) Foreign Application Priority Data
Jul. 26, 2018 (KR) 10-2018-0087390
Jul. 24, 2019 (KR) 10-2019-0089900

(51) Int. Cl. B01J 20/16; G21F 9/12; B01J 20/30

(52) U.S. Cl. CPC B01J 20/165; B01J 20/3078; G21F 9/12

(57) ABSTRACT

Provided is a radionuclide absorbent, a method of preparing the same and a method of removing a radionuclide using the same. The radionuclide absorbent, compared to conventional zeolite, may more selectively remove radioactive cesium (Cs⁺) and/or strontium (Sr²⁺) ions even in the presence of various competitive ions (e.g., Na⁺, K⁺, Mg²⁺, and Ca²⁺) in groundwater or seawater. In addition, the radionuclide absorbent may be prepared by a simple method of thermally treating a mixture of sulfur and zeolite, and thereby, sulfur may be uniformly dispersed in zeolite.

### BACKGROUND

### 1. Field of the Invention

The present invention relates to a radionuclide absorbent, a method of preparing the same, and a method of removing a radionuclide using the same, and more particularly, to a radionuclide absorbent enabling selective removal of a radionuclide even in the presence of various competitive ions (e.g., Na⁺, K⁺, Mg²⁺, and Ca²⁺) in groundwater or seawater, a method of preparing the same, and a method of removing a radionuclide using the same.

### 2. Discussion of Related Art

As the amount of energy used by modern humans increases greatly, the development of new energy sources that will replace fossil fuels is considered a major issue, and among these energy sources, nuclear energy has been already widely used in many countries. However, nuclear power generation involves problems such as the reprocessing of thousands of tons of radioactive waste and nuclear fuel, which are annually generated after the use of nuclear fuel, and radioisotopes such as cesium (¹³⁷Cs⁺) and strontium (⁹⁰Sr²⁺) ions actually generated during the operation & maintenance of nuclear-related facilities and the use of radioisotopes have high water solubility, high nuclear fission energy, and a long half-life of about 30 years (Delacroix, D.; Guerre, J. P.; Leblanc, P.; Hickman, C. Radionuclide and Radiation Protection Data Handbook 2002. Radiat. Prot. Dosim. 2002, 98, 1-168). Therefore, it is very important to safely treat and store these materials.

Radioactive wastes can be divided into high-level and low-level radioactive wastes according to the level of radioactivity, the low-level radioactive waste is divided into a gas, a liquid and a solid according to its form, and among these, liquid waste is concentrated through precipitation, evaporation, adsorption and ion exchange, and then solidified in a drum, or chemically treated and diluted with a large amount of water, followed by discharging (El-Kamash, A. M.; El-Naggar, M. R.; El-Dessouky, M. I. Immobilization of Cesium and Strontium Radionuclides in Zeolite-Cement Blends. J. Hazard. Mater. 2006, 136, 310-316). Research on removing a very small amount of cesium ions (¹³⁷Cs⁺) generated in the above procedure and dissolved in groundwater and seawater has been steadily progressing, and it is known in the art that inorganic ion exchange materials and polymer ion exchange resins are used to remove radionuclides from an aqueous solution.

Particularly, since the inorganic ion exchange materials are stable under an enormous amount of heat and radioactive conditions (Sylvester, P.; Clearfield, A. The Removal of Strontium and Cesium from Simulated Hanford Groundwater Using Inorganic Ion Exchange Materials. Solvent Extr. Ion Exch. 1998, 16, 1527-1539), they are widely used as radionuclide adsorbents. Representative examples include zeolite, clays, and porous metal oxide-based materials (metal oxidic sorbents). While zeolite and clays are widely used as common adsorbents due to low costs, it is known that they exhibit relatively low adsorption selectivity for a radionuclide in the presence of a high concentration of competitive ions (Sinha, P. K; Panicker, P. K.; Amalraj, R. V.; Krishnasamy, V. Treatment of Radioactive Liquid Waste Containing Caesium by Indigenously Available Synthetic Zeolites: A Comparative Study. Waste Manage. 1995, 15, 149-157). Recently, various inorganic ion exchange materials having higher selectivity have been reported, and examples of the inorganic ion exchange materials may include silicon titanate (U.S. Pat. No. 6,110,378A), crystalline silicotitanate (CST, UOP IE-911), vanadosilicate (WO2015129941A1), metal sulfides (U.S. Pat. No. 9,056,263B2), and metal hexacyanoferrates (EP0575612A1). Particularly, among these, crystalline silicotitanate (CST) is a material recently applied to the removal of radionuclides released during the Fukushima nuclear accident, and is known to be chemically stable in a wide pH range and exhibit high adsorption selectivity for cesium (Cs⁺) and strontium (Sr²⁺) ions in the presence of various competitive ions. However, these ion exchange materials include various transition metals (Sn, Sb, In, Ge, V, Ti, etc.), and compared to existing zeolite and clays, the price is high and the preparation method is complex, and there are many restrictions on application. Therefore, it is necessary to develop an economical ion exchange material enabling the selective removal of a radionuclide in the presence of a large amount of competitive ions present in groundwater and seawater.

For this reason, the inventors intend to provide an adsorbent having high adsorption selectivity for radionuclides such as cesium (Cs⁺) and strontium (Sr²⁺) ions in the presence of competitive ions by preparing a sulfur-zeolite composite by mixing sulfur with zeolite having a cation exchange property, and a method of preparing the same. In addition, they intend to provide a method of selectively removing very small amounts of cesium (Cs⁺) and strontium (Sr²⁺) ions in the presence of a large amount of competitive ions and competitive ions actually present in groundwater using the above-described adsorbent.

### PRIOR ART DOCUMENTS

### Patent Document

Korean Unexamined Patent Application Publication No. 10-2016-0087076

### Non-Patent Document

Sinha, P. K.; Panicker, P. K.; Amalraj, R. V.; Krishnasamy, V. Treatment of Radioactive Liquid Waste Containing Caesium by Indigenously Available Synthetic Zeolites: A Comparative Study. Waste Manage. 1995, 15, 149-157

### SUMMARY OF THE INVENTION

The present invention is directed to providing a radionuclide absorbent including a sulfur-zeolite composite in which sulfur is dispersed in zeolite, and a method of preparing the radionuclide absorbent by mixing sulfur with zeolite having a cation exchange property.

The present invention is also directed to providing a method of selectively removing very small amounts of cesium (Cs⁺) and/or strontium (Sr²⁺) ions in the presence of a large amount of competitive ions and competitive ions actually present in groundwater using the adsorbent.

However, technical problems to be solved in the present invention are not limited to the above-described problems, and other problems which are not described herein will be fully understood by those of ordinary skill in the art from the following descriptions.

The present invention provides a radionuclide absorbent including a sulfur-zeolite composite in which sulfur is dispersed in zeolite.

In addition, the present invention provides a method of preparing a radionuclide absorbent by thermally treating a mixture of sulfur and zeolite.

In addition, the present invention provides a method of removing a radionuclide by adsorbing a radionuclide by bringing a radionuclide absorbent including a sulfur-zeolite composite in which sulfur is dispersed in zeolite into contact with a solution containing cesium or strontium ions.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 schematically shows a process of preparing a sulfur-zeolite composite according to an exemplary embodiment of the present invention;

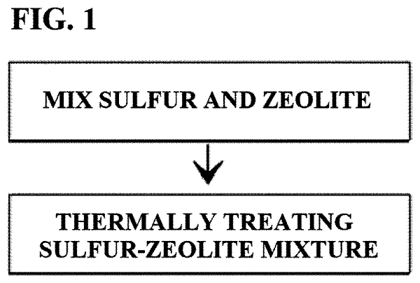

FIG. 2 is a graph showing the results of X-ray diffraction (XRD) analyses for zeolites and sulfur-zeolite composites;

FIG. 3 shows dark field images, obtained by transmission electron microscopy, and results of element distribution analyzed by energy dispersive spectroscopy (EDS) for sulfur-zeolite composites. (a), (b), (c) and (d) indicate S-NaA, S-NaX, S-CHA and S-MOR, respectively, and yellow represents the distribution of a silicon element, red represents the distribution of a sulfur element, blue represents the distribution of a sodium element, and green represents the distribution of an aluminum element;

FIG. 4 is a set of graphs showing ion-exchange isotherms for zeolites and sulfur-zeolite composites;

FIG. 5A is a graph showing the result of analyzing the Cs⁺ distribution coefficient (K_{d}, mL g_{zeolite}⁻¹) and ion removal rate (Cs⁺ removal, %) for zeolites and sulfur-zeolite composites in a solution with a composition (1 ppm Cs⁺, 125 ppm Na⁺, 25 ppm Ca²⁺, 10 ppm Mg²⁺, 5 ppm K⁺) similar to groundwater contaminated with a radionuclide Cs⁺;

FIG. 5B is a graph showing the result of analyzing the Sr²⁺ distribution coefficient (K_{d}, mL g_{zeolite}⁻¹) and ion removal rate (Sr²⁺ removal, %) for zeolites and sulfur-zeolite composites in a solution with a composition (1 ppm Cs⁺, 125 ppm Na⁺, 25 ppm Ca²⁺, 10 ppm Mg²⁺, 5 ppm K⁺) similar to groundwater contaminated with radionuclide Sr²⁺;

FIG. 6A is a graph showing the results of XRD analyses for zeolite (NaX) and a sulfur (S)-zeolite (NaX) composite;

FIG. 6B is a graph showing the results of specific surface area analyses for zeolite (NaX) and a sulfur (S)-zeolite (NaX) composite;

FIG. 6C is a set of TEM images of zeolite (NaX) and a sulfur (S)-zeolite (NaX) composite;

FIG. 7 is a graph showing the result of analyzing the Cs⁺ removal rate and distribution coefficient (K^{d}) for zeolite (NaX) and a sulfur (S)-zeolite (NaX) composite.

FIG. 8 is a graph showing the result of analyzing the Cs⁺ or Sr²⁺ removal rate and distribution coefficient (K_{d}) for zeolite (CHA) and a sulfur (S)-zeolite (CHA) composite;

FIG. 9 is a graph showing the result of analyzing Cs⁺ and Sr²⁺ removal rates for zeolite (CHA) and a sulfur (S)-zeolite (CHA) composite in a solution with a composition (1 ppm Cs⁺, 0.7 ppm Sr²⁺, 125 ppm Na⁺, 25 ppm Ca²⁺, 10 ppm Mg²⁺, 5 ppm K⁺) similar to groundwater contaminated with radionuclides Cs⁺ and Sr²⁺; and

FIG. 10 is a set of graphs showing the results of analyzing the Cs⁺ distribution coefficient (K_{d}, mL g_{zeolite}⁻¹) and Cs⁺ removal rate (Cs⁺ removal, %) for zeolites and sulfur-zeolite composites in a 1 ppm Cs⁺ solution containing sodium (Na⁺) and calcium (Ca²⁺) as competitive ions.

### DETAILED DESCRIPTION OF EXEMPLARY EMBODIMENTS

Hereinafter, the present invention will be described in further detail with reference to exemplary embodiments. The objects, features and advantages of the present invention are easily understood through the following exemplary embodiments. The present invention is not limited to exemplary embodiments to be described below, but may be embodied in other forms. The exemplary embodiments presented herein are provided such that the idea of the present invention can be fully conveyed to those of ordinary skill in the art to which the present invention belongs. Therefore, the present invention should not be limited by the following exemplary embodiments.

Unless defined otherwise, technical and scientific terms used herein each has a meaning ordinarily understood by those of ordinary skill in the art to which the present invention belongs. Generally, the nomenclature used herein is well known and commonly used in the art.

A sulfur-zeolite composite of the present invention was prepared by uniformly dispersing sulfur in zeolite by thermally treating a mixture of sulfur and zeolite, and it was found that the composite formed thereby, compared to conventional zeolite, can more selectively remove radioactive cesium (Cs⁺) and strontium (Sr²⁺) ions even in the presence of various competitive ions (e.g., Na⁺, K⁺, Mg²⁺ and Ca²⁺) in groundwater or seawater, and thus the present invention was completed.

Various methods, for example, liquid-liquid extraction, precipitation and adsorption, have been studied to treat radioactive materials such as Cs and Sr. The liquid-liquid extraction exhibits high selectivity for metal ions and excellent removal capability, but needs a large amount of organic solvent, and due to solubility, has a disadvantage in that an organic solvent may be lost in a liquid phase. The precipitation is a method of precipitating metal ions by adding a coagulant or precipitate, and has a disadvantage of taking too much time for recovery of a coagulant and a product, repeated use of a coagulant and precipitate separation. On the other hand, the adsorption has been known to have a low cost and to be easily carried out, compared to other processes, and representatively, activated carbon, ion exchange resins, activated alumina, silica gel, zeolites and clays are widely used as adsorbents. However, these adsorbents have shown problems of relatively low adsorption selectivity for radionuclides in the presence of a high concentration of competitive ions.

To solve the above-described problems, the present invention provides a method of preparing a radionuclide absorbent by thermally treating a mixture of sulfur and zeolite. In addition, the present invention provides a radionuclide absorbent including a sulfur-zeolite composite in which sulfur is dispersed in zeolite.

Hereinafter, the present invention will be described in detail.

The present invention provides a method of preparing a radionuclide absorbent, which includes thermally treating a mixture of sulfur and zeolite. The radionuclide may include one or more of cesium and strontium.

Step of Preparing Mixture of Sulfur and Zeolite

Before preparation of the mixture, water molecules in zeolite may be removed through thermal treatment, but the present invention is not limited thereto.

The mixture may be prepared by physically mixing sulfur and zeolite. The procedure of physically mixing zeolite and sulfur preferably uses elemental sulfur, but the present invention is not limited thereto, and may be performed by bringing zeolite into contact with a mixture having one or more sulfur molecules.

In this method, on the basis of the total weight (100 wt %) of the mixture of sulfur and zeolite, sulfur may be mixed at 1 to 25 wt % or 3 to 20 wt %. As a sulfur content in the sulfur-zeolite composite increases, it is advantageous for cesium ion adsorption. However, when about 24 to 25 wt % of sulfur is included, the specific surface area of NaX that has the widest specific surface area among zeolites is almost 0, and therefore, the upper limit range may be the largest amount of sulfur that can be incorporated into zeolite by thermal treatment (sublimation). As a result, it may be economical to mix the sulfur content within the range, and when the sulfur content is less than 1 wt %, there may be a problem of insignificant improvement in radionuclide ion selectivity.

In addition, in the method, on the basis of the total weight (100 wt %) of the mixture of sulfur and zeolite, sulfur may be mixed at 4 to 12 wt %. As a sulfur content in the composite increases, it is advantageous for adsorption of cesium ions, but disadvantageous for adsorption of strontium ions. Within this range, simultaneous removal of cesium ions and strontium ions can be most efficiently performed.

The zeolite may be aluminosilicate zeolite. The term “aluminosilicate zeolite” used herein refers to a zeolite material essentially including silicon atoms and aluminum atoms in the crystal lattice structure thereof.

More specifically, the zeolite may be one selected from the group consisting of chabazite (CHA), mordenite (MOR), NaA, NaX, faujasite (FAU), Linde Type A (LTA), analcime (ANA), Linde Type L (LTL), EMT (EMC-2), MFI (ZSM-5), ferrierite (FER), heulandite (HEU), beta polymorph A (BEA) and MTW (ZSM-12) structures, or a combination thereof.

The molar ratio of silicon (Si)/aluminum (Al) of the aluminosilicate zeolite may be 1 to 100, and more preferably, 1 to 20. There is no zeolite having a molar ratio of less than 1, and when the molar ratio of zeolite is more than 100, sulfur dispersion is not uniform.

Thermal Treatment

A sulfur-zeolite composite in which sulfur is uniformly dispersed in zeolite may be prepared by sublimating sulfur through the thermal treatment.

The thermal treatment temperature may be 50 to 700° C., preferably, 90 to 500° C., more preferably 130 to 400° C., and most preferably 150 to 350° C. When the thermal treatment temperature is less than 50° C., sulfur dispersion is not uniform, and when the thermal treatment temperature is more than 700° C., sulfur is evaporated.

The thermal treatment may be performed for 1 to 48 hours.

The thermal treatment may consist of first thermal treatment and second thermal treatment.

In addition, the present invention provides a radionuclide absorbent including a sulfur-zeolite composite in which sulfur is dispersed in zeolite.

The composite may include 1 to 25 wt % or 3 to 20 wt % of sulfur on the basis of the total weight (100 wt %) of the composite. As the sulfur content increases, it is advantageous for cesium ion adsorption, but when the composite includes about 24 to 25 wt % of sulfur, the specific surface area of NaX that has the widest specific surface area among zeolites is almost 0. Therefore, the upper limit range may be the largest amount of sulfur that can be incorporated into zeolite by thermal treatment (sublimation).

In addition, the composite may include 4 to 12 wt % of sulfur on the basis of the total weight (100 wt %) of the composite. As the sulfur content in the composite increases, it is advantageous for the adsorption of cesium ions, but disadvantageous for the adsorption of strontium ions. Within the above range, simultaneous removal of cesium ions and strontium ions is most efficiently performed.

The zeolite may be one selected from the group consisting of chabazite (CHA), mordenite (MOR), NaA, NaX, faujasite (FAU), Linde Type A (LTA), analcime (ANA), Linde Type L (LTL), EMT (EMC-2), MFI (ZSM-5), ferrierite (FER), heulandite (HEU), beta polymorph A (BEA) and MTW (ZSM-12) structures, or a combination thereof.

The composite may include 1 to 25 wt % of sulfur on the basis of the total weight (100 wt %) of the composite, and in this case, a radionuclide to be adsorbed may be a cesium ion. Here, the zeolite may be NaX.

In addition, the composite may include 4 to 12 wt % of sulfur on the basis of the total weight (100 wt %) of the composite, and in this case, radionuclides to be adsorbed may include cesium and strontium. Here, the zeolite may be chabazite (CHA).

The composite may be prepared by sublimating sulfur through thermal treatment of a mixture of sulfur and zeolite.

The present invention also includes a method of removing a radionuclide, which includes adsorbing a radionuclide by bringing the sulfur-zeolite composite prepared by thermally treating the mixture of sulfur and zeolite into contact with a solution containing cesium or strontium ions.

The method uses the sulfur-zeolite composite as an adsorbent, and may remove radionuclides such as cesium (Cs⁺) and strontium (Sr²⁺) ions by dispersing the composite in an aqueous solution or by using the composite as a packed bed.

Hereinafter, to help in understanding the present invention, exemplary examples will be suggested. However, the following examples are merely provided to more easily understand the present invention, and not to limit the present invention.

### EXAMPLE

### Example 1: Preparation of Sulfur-Zeolite Composite (Radionuclide Adsorbent)

2 g each of zeolites such as chabazite (named “CHA”), NaA, NaX, mordenite (named “MOR”) was mixed with 0.222 g of sulfur at room temperature for 30 minutes. Afterward, the mixture was thermally treated at 433 K for 1 hour and at 593 K for 10 hours, thereby synthesizing a sulfur-zeolite composite. The samples prepared as described above were named “S-CHA”, “S-NaA”, “S-NaX”, and “S-MOR,” respectively.

### Experimental Examples

### Experimental Example 1: Analysis of X-Ray Diffraction Patterns

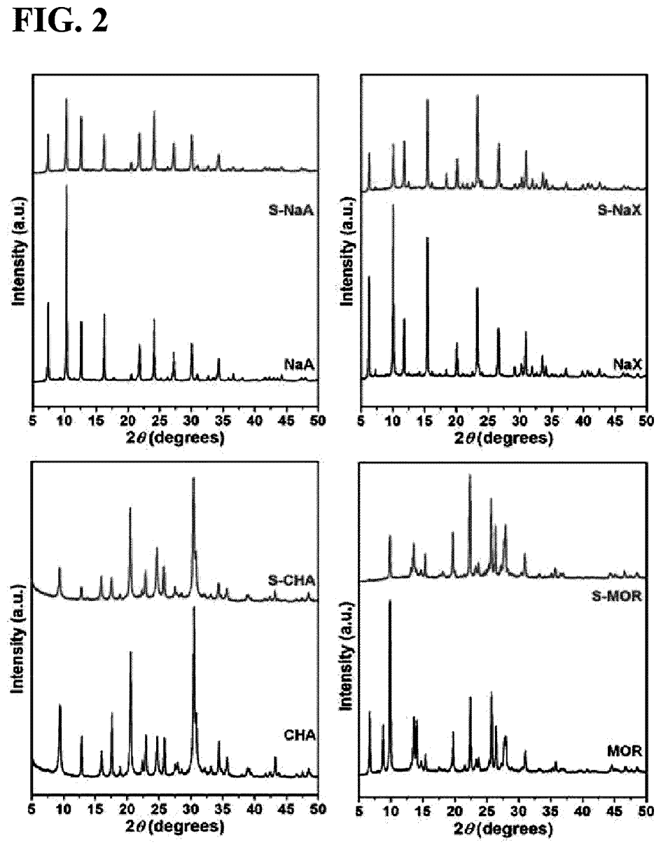

The crystal structures of zeolites and sulfur-zeolite composites were analyzed using an X-ray diffractometer (XRD, Rigaku, D/MAX2100H), and FIG. 2 shows the results of X-ray diffraction (XRD) analyses for the zeolite and the sulfur-zeolite composites. All sulfur-zeolite composites show a strong diffraction peak at 2θ at the same position as the corresponding zeolites, indicating that the zeolite framework is not disrupted in the process of preparing a sulfur-zeolite composite. In addition, there was no diffraction peak corresponding to elemental sulfur, indicating that sulfur is very uniformly dispersed with a small size in the zeolite.

### Experimental Example 2: Analysis of Element Distribution in Sulfur-Zeolite Composites

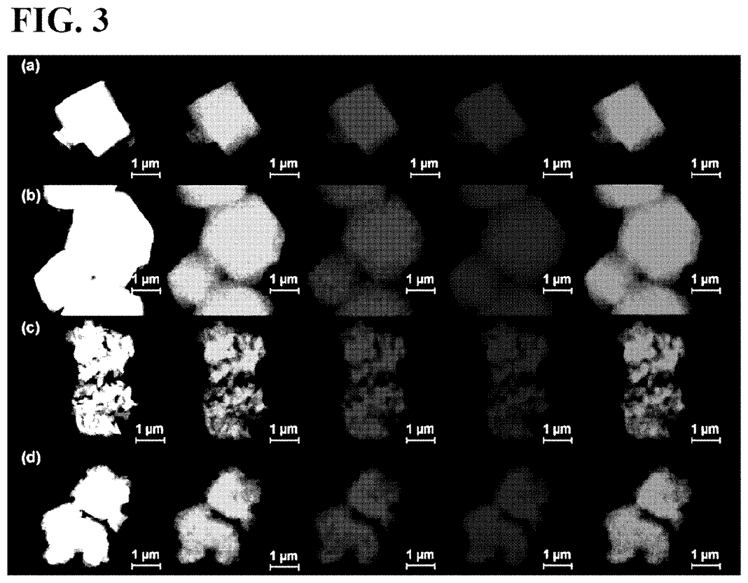

FIG. 3 shows dark field images, obtained by transmission electron microscopy, and results of element distribution analyzed by energy dispersive spectroscopy (EDS) for sulfur-zeolite composites. (a), (b), (c) and (d) indicate S-NaA, S-NaX, S-CHA and S-MOR, respectively, and yellow represents the distribution of a silicon element, red represents the distribution of a sulfur element, blue represents the distribution of a sodium element, and green represents the distribution of an aluminum element. In all samples, it can be confirmed that sulfur is uniformly dispersed in a zeolite crystal.

### Experimental Example 3: Evaluation of Cesium Ion (Cs⁺) Removal Capability of Zeolites and Sulfur-Zeolite Composites in Aqueous Solution

The cesium ion (Cs⁺) removal capability was evaluated for the zeolites and sulfur-zeolite composites prepared in Example 1 using an aqueous solution ion exchange method as follows. All ion exchange adsorption experiments were performed by bringing 0.02 g to 0.3 g of the zeolite or sulfur-zeolite composite into contact with 200 mL of an aqueous solution (prepared using CsCl) including 100 ppm of cesium ions (Cs⁺) at room temperature while stirring at a speed of 400 rpm for 3 hours. After stirring, the Cs⁺ concentration in the solution was measured using an inductively coupled plasma mass spectrometer.

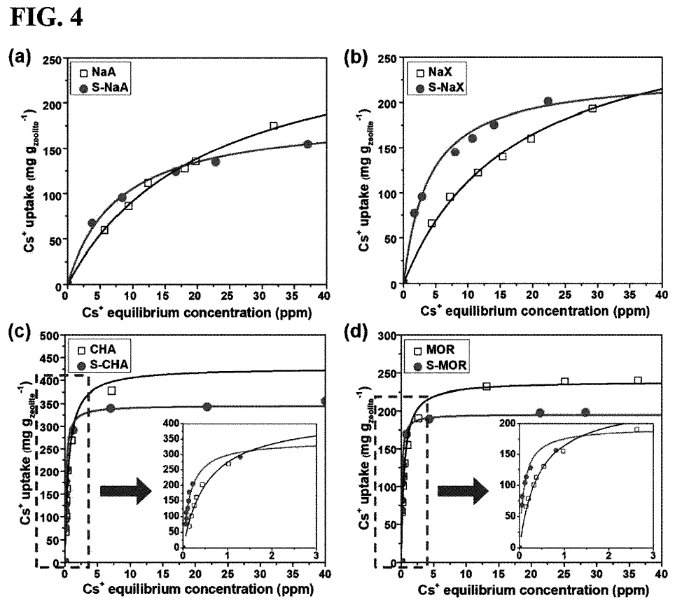

FIG. 4 shows the ion-exchange isotherms obtained when the zeolite and sulfur-zeolite composite are brought into contact with an aqueous solution containing 100 ppm of cesium ions (Cs⁺). In all ion exchange adsorption experiments, the slope of the ion exchange isotherm of the sulfur-zeolite composite prepared according to the above-described method is higher than that of zeolite in the presence of a low concentration of Cs⁺, indicating that the selectivity for cesium ions (Cs⁺) of the sulfur-zeolite composite is significantly higher than that of the corresponding zeolite.

Table 1 is a table summarizing an adsorption amount (qₘₐₓ, mg g_{zeolite}⁻¹) and an adsorption constant (b, kg me) obtained by analyzing the ion exchange isotherms of FIG. 4 using a Langmuir adsorption model. The adsorption constant of the prepared sulfur-zeolite composite is increased 278 to 440%, compared to the corresponding zeolite, confirming that the cesium ion (Cs⁺) selectivity of the sulfur-zeolite composite greatly increases, compared to zeolite.

TABLE 1

| | qₘₐₓ | b | |
|---|---|---|---|
| | (mg g_{zeolite}⁻¹) | (kg mg⁻¹) | R² |
| NaA | 289 | 0.0464 | 0.99 |
| S-NaA | 187 | 0.129 | 0.98 |
| NaX | 308 | 0.0577 | 0.99 |
| S-NaX | 231 | 0.254 | 0.97 |
| CHA | 428 | 1.78 | 0.99 |
| S-CHA | 346 | 6.16 | 0.99 |
| MOR | 239 | 2.25 | 0.99 |
| S-MOR | 196 | 9.51 | 0.99 |

As shown in FIG. 4 and Table 1, in the cases of zeolites (S-NaA, S-NaX, S-CHA and S-MOR) consisting of sulfur and a composite material, compared to the corresponding pure zeolites (NaA, NaX, CHA and MOR), the ion exchange isotherm is more steeply elevated at a low concentration of Cs⁺, showing a more improved adsorption constant (b, kg mg⁻¹). This result shows that sulfur dispersed in zeolite raised Cs⁺ adsorption selectivity in ion exchange.

### Experimental Example 4: Evaluation of Capability of Removing Cesium (Cs⁺) or Strontium (Sr²⁺) Ions in Groundwater Composition for Zeolites and Sulfur-Zeolite Composites

Evaluation of Cesium Ion (Cs⁺) Removal Capability

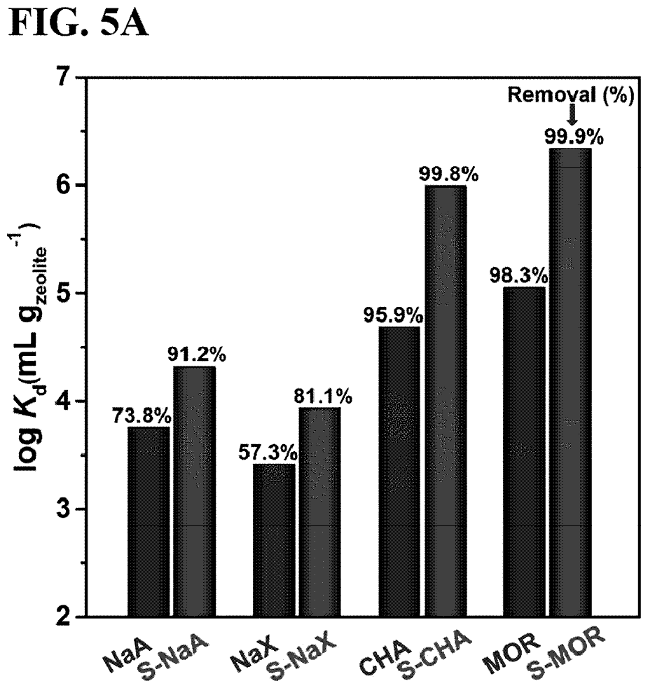

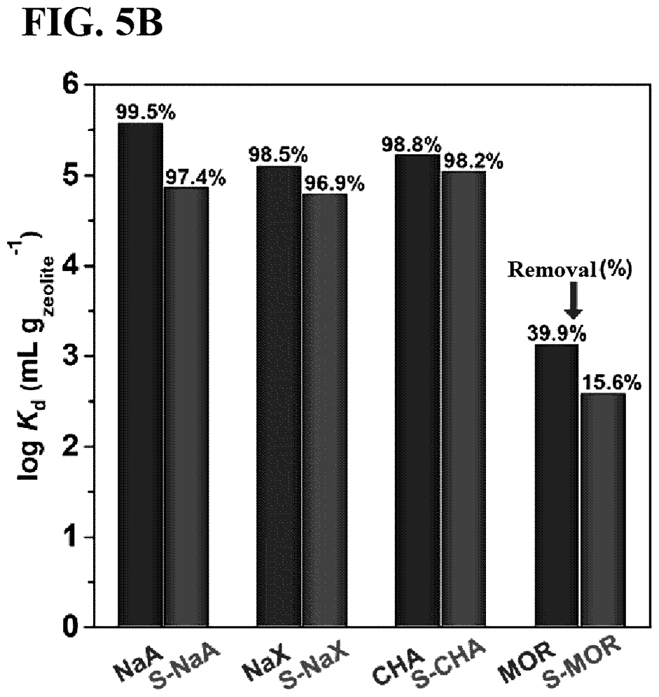

The Cs⁺ removal capability was evaluated for the zeolites and sulfur-zeolite composites prepared in Example 1 using an ion exchange method in an aqueous solution similar to a real groundwater composition. A solution containing 1 ppm Cs⁺, 125 ppm Na⁺, 25 ppm Ca²⁺, 10 ppm Mg²⁺, and 5 ppm K⁺, which is similar to a groundwater condition contaminated with a radionuclide (Datta, S. J.; Moon, W. K.; Choi, D. Y.; Hwang, I. C.; Yoon, K. B. A Novel Vanadosilicate with Hexadeca-Coordinated Cs⁺ Ions as a Highly Effective Cs⁺ Remover. Angew. Chem. Int. Ed. 2014, 53, 7203-7208) was prepared using CsCl, NaCl, CaCl₂.2H₂O, MgCl₂.6H₂O, and KCl. An ion exchange experiment was performed by bringing 0.1 g of zeolite and 0.111 g of a sulfur-zeolite composite (having the same volume as 0.1 g of general sulfur-free zeolite, because the zeolite weight in 0.111 g of a sulfur-zeolite composite containing 10 wt % of sulfur is 0.1 g; even in a subsequent adsorption experiment, sulfur-zeolite composites containing various wt % of sulfur had the same weight of zeolite; this is because, while the sulfur-zeolite composites containing sulfur became heavier by the sulfur weight, compared to zeolite, sulfur was present in a pore of zeolite, and therefore there was no volume change regardless of the presence or absence of sulfur, and since a volume is a more critical factor than a weight of an adsorbent when actually applied to a column or when disposing radioactive waste, all adsorption experiments were performed with the same weight of zeolite to compare the experimental results of the sulfur-zeolite composites with the same volume) into contact with 200 mL of the aqueous solution at room temperature, and stirring the resulting mixture at 400 rpm for 3 hours. FIG. 5A shows the Cs⁺ distribution coefficient (K_{d}, mL g_{zeolite}⁻¹) and ion removal rate (Cs⁺ removal, %) when zeolites and sulfur-zeolite composites are brought into contact with a solution with a composition similar to radioactive Cs⁺-contaminated groundwater (1 ppm Cs⁺, 125 ppm Na⁺, 25 ppm Ca²⁺, 10 ppm Mg²⁺, 5 ppm K⁺). Referring to FIG. 5A, it can be seen that all of the sulfur-zeolite composites exhibit a much higher distribution coefficient (K_{d}, mL g_{zeolite}⁻¹) and a higher cesium ion removal rate (Cs⁺ removal, %), compared to the corresponding zeolites. This result comes from a HSAB theory in which, since Cs⁺, compared to competitive ions such as Na⁺, Ca²⁺, Mg²⁺ and K⁺ in groundwater, is a softer/less hard acid, it has a high chemical affinity with sulfur, which is a soft base, and thus is improved in Cs⁺ removal capability even under a groundwater condition containing a large amount of competitive ions. For this reason, the same effect is expected for other types of zeolite.

Evaluation of Strontium Ion (Sr²⁺) Removal Capability

Since zeolites are known as materials that are basically ion-exchangeable with divalent ions (e.g., heavy metals and Sr), the removal characteristic for a major radionuclide Sr²⁺, other than Cs⁺, was analyzed, and the result is shown in FIG. 5B. Referring to FIG. 5B, the Sr²⁺ removal capability was evaluated for the zeolites and sulfur-zeolite composites (containing 10 wt % of sulfur on the basis of the total weight of a composite, 10S-Zeolite) prepared in Example 1, using an ion exchange method in an aqueous solution with a composition (1 ppm Sr²⁺, 125 ppm Na⁺, 25 ppm Ca²⁺, 10 ppm Mg²⁺, 5 ppm K⁺) similar to a real groundwater composition. Referring to FIG. 5B, it was confirmed that the Sr²⁺ removal rate and distribution coefficient (K_{d}) of each of 4 types of sulfur-zeolite composites containing sulfur are slightly lowered. This result comes from the HSAB theory, considering that, since Sr is basically a hard acid, it has a low chemical affinity with sulfur, which is a soft base, and thus Si does not easily have an ion exchange reaction with zeolite containing a large amount of sulfur.

Analysis of Relationship Between Sulfur (S) Amount and Cesium (Cs) Removal Effect

According to the experimental result, when sulfur (S) is added, it is confirmed to be advantageous for cesium (Cs) removal. To confirm the relationship between a sulfur (S) amount and a cesium (Cs) removal effect, as the amount of sulfur was increased, the change in cesium (Cs) removal characteristic was analyzed using the NaX zeolite.

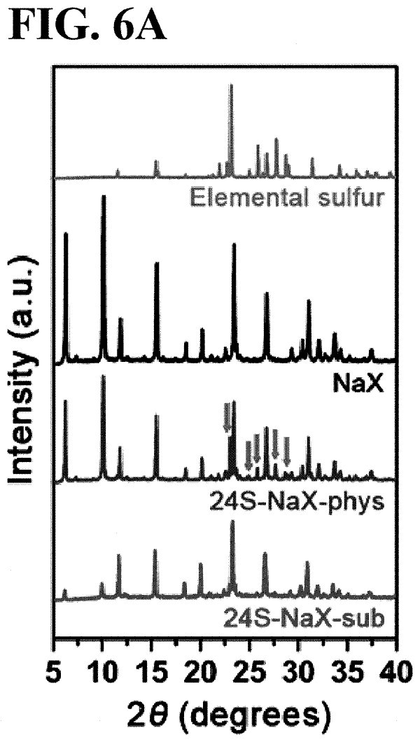

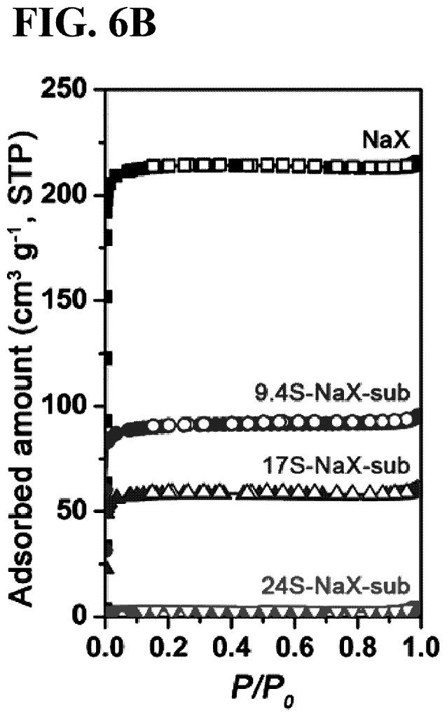

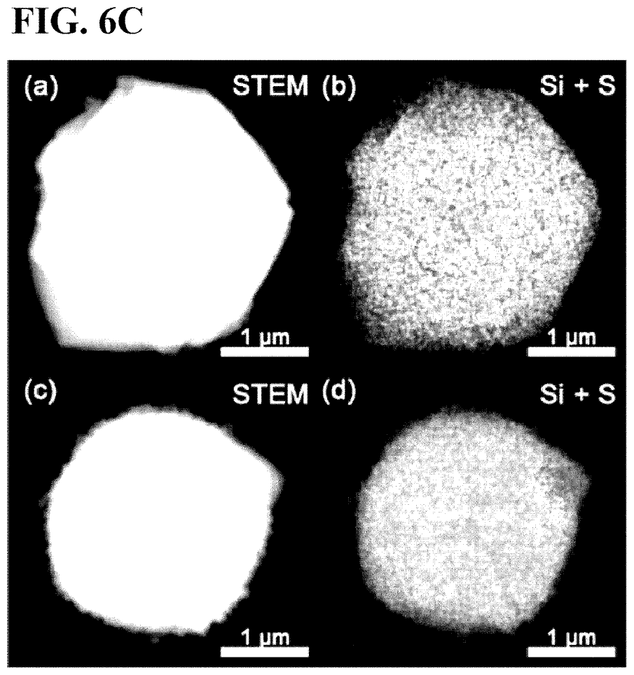

S-NaX containing 9.4 wt %, 17 wt % or 24 wt % of sulfur on the basis of the total weight of a sulfur-NaX zeolite composite was prepared, and then the XRD, specific surface area and TEM image thereof were analyzed, and the results are shown in FIG. 6. Sub is an abbreviation of sublimation, and refers to a state in which sulfur is homogeneously saturated in a NaX pore by mixing sulfur and NaX and sublimating (thermally treating) sulfur. Phys is prepared by physically mixing zeolite and sulfur without sublimation of sulfur, and in this case, sulfur is non-uniformly mixed by a capillary phenomenon ((c) and (d) of FIG. 6C). As a result of the specific surface area analysis of FIG. 6B, when sulfur is contained at 24 wt %, the surface area becomes 10 m²/g, which is close to 0, indicating that, in the case of NaX, 24 wt % is the highest amount that can be sublimated. However, since zeolites have different specific surface areas, it is expected that the highest amount of sulfur contained varies.

TABLE 2
Physicochemical properties of NaX and sulfur-NaX composite

| | | | # of sulfur | | | |
|---|---|---|---|---|---|---|
| | Sulfur | | atoms | | | |
| | loading | Unit cell | per | S_{BET}^{a} | V_{micro}^{b} | Vₜₒₜₐₗ^{c} |
| Sample | (wt %) | composition | supercage | (m² g⁻¹) | (cm³ g⁻¹) | (cm³ g⁻¹) |
| NaX | 0 | Na₈₆(AlO₂)₈₆(SiO₂)₁₀₆ | 0 | 715 | 0.318 | 0.330 |
| 9.4S-NaX-phys | 9.4 | S₄₃Na₈₆(AlO₂)₈₆(SiO₂)₁₀₆ | 5.4 | 418 | 0.179 | 0.196 |
| 9.4S-NaX-sub | | | | 305 | 0.130 | 0.144 |
| 17S-NaX-phys | 17 | S₈₆Na₈₆(AlO₂)₈₆(SiO₂)₁₀₆ | 11 | 283 | 0.121 | 0.132 |
| 17S-NaX-sub | | | | 191 | 0.084 | 0.090 |
| 24S-NaX-phys | 24 | S₁₂₉Na₈₆(AlO₂)₈₆(SiO₂)₁₀₆ | 16 | 155 | 0.066 | 0.073 |
| 24S-NaX-sub | | | | 10 | 0.004 | 0.004 |

^{a}BET surface areas were determined in the P/Pₒ range of 0.08-0.20.
^{b}Micropore volumes (V_{micro}) were determined using t-plot method.
^{c}Total pore volumes (Vₜₒₜₐₗ) were determined at P/Pₒ = 0.95.

Since the sizes of micropore volumes of 4 types of zeolite below are lowered in the order of NaX>NaA>CHA MOR and thus NaX can contain the largest amount of S, the maximum encapsulation amount of sulfur with respect to different zeolites is lowered in the order of NaX>NaA>CHA MOR, which is the same as the order of the micropore volume sizes, and the sulfur encapsulation amount with respect to a zeolite weight is expected to be approximately 15 to 25%.

TABLE 3
Physical properties of sulfur-zeolite composite
(containing 10 wt % of sulfur) and zeolite

| sample | Si/Al | unit cell composition | V_{micro} (cm³g⁻¹) |
|---|---|---|---|
| NaA | 1.0 | Na₁₂(AlO₂)₁₂(SiO₂)₁₂ | 0.243 |
| S-NaA | | S_{5.2}Na₁₂(AlO₂)₁₂(SiO₂)₁₂ | 0.019 |
| NaX | 1.2 | Na₈₆(AlO₂)₈₆(SiO₂)₁₀₆ | 0.308 |
| S-NaX | | S_{46.5}Na₈₆(AlO₂)₈₆(SiO₂)₁₀₆ | 0.148 |
| CHA | 2.0 | Na_{8.9}K_{2.1}(AlO₂)₁₁(SiO₂)₂₂ | 0.219 |
| S-CHA | | S_{7.8}Na_{8.9}K_{2.1}(AlO₂)₁₁(SiO₂)₂₂ | 0.092 |
| MOR | 6.5 | Na_{6.4}(AlO₂)_{6.4}(SiO₂)_{41.6} | 0.219 |
| S-MOR | | S_{10.5}Na_{6.4}(AlO₂)_{6.4}(SiO₂)_{41.6} | 0.098 |

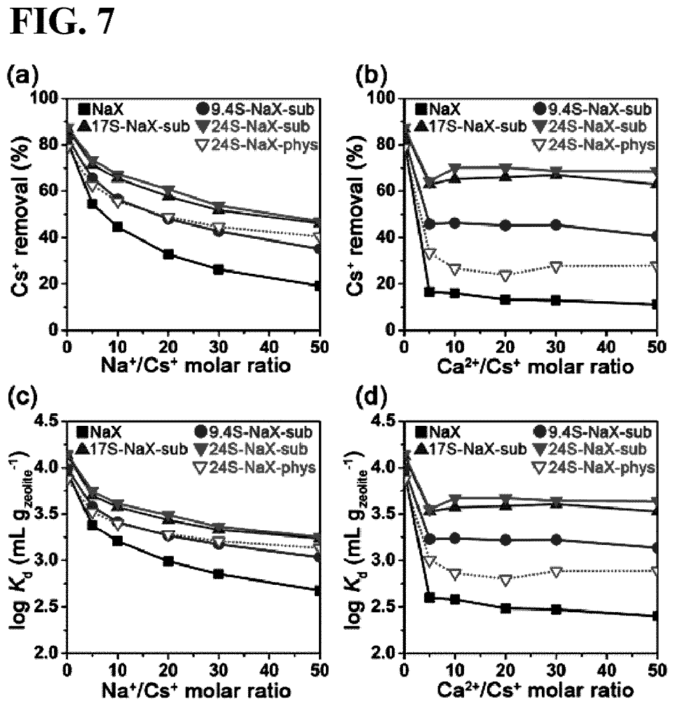

The Cs⁺ removal rate and distribution coefficient (k_{d}), in 200 mL of distilled water containing 1 ppm of Cs⁺ and Ca⁺ and Na⁺ at up to 50-fold moles higher than Cs⁺, were analyzed using 100 mg each (for example, when using 131.6 mg, the sulfur-zeolite composite containing 24 wt % of sulfur has a weight of 100 mg on the basis of the zeolite weight) of general sulfur (S)-free zeolite and sulfur-zeolite (S-Nax) composites (respectively containing 9.4, 17 and 24 wt % of sulfur) on the basis of a zeolite weight, and the results are shown in FIG. 7.

Referring to FIG. 7, it was confirmed that, as more sulfur is added, a Cs⁺ removal rate and a distribution coefficient (K_{d}) increase, and this result is determined to come from the HSAB theory. When only physical mixing is performed without thermal treatment, the Cs⁺ removal rate and the K_{d} value were higher than general NaX, but due to non-uniform dispersion of sulfur, performance was lower than a thermally-treated composite. In addition, it was confirmed that the S-NaX composite containing 24 wt % of sulfur exhibited the highest performance.

Analysis of Sulfur Content Suitable for Simultaneous Removal of Sr²⁺ and Cs⁺

As more sulfur (S) is contained in a sulfur-zeolite composite, it is advantageous for Cs⁺ removal, but not for Sr²⁺ removal. Accordingly, the following experiment was carried out to find a sulfur content suitable for simultaneous removal of Sr²⁺ and Cs⁺.

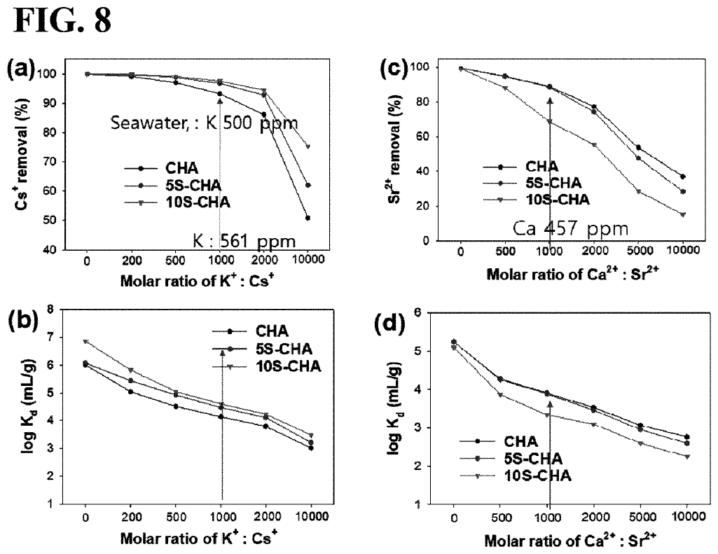

The Cs⁺ removal rate and distribution coefficient (k_{d}), in 20 mL of distilled water containing 1 ppm of Cs⁺ and a competitive ion, K⁺, at an amount up to 10,000-fold higher than the Cs⁺ mole number, were analyzed using 10 mg each (for example, when using 11.11 mg, the sulfur-zeolite composite containing 10 wt % of sulfur has a weight of 10 mg on the basis of the zeolite weight) of sulfur (S)-zeolite (CHA) composites containing 10 wt % and 5 wt % of sulfur on the basis of the total weight of the sulfur-zeolite composite and zeolite (CHA) on the basis of a zeolite weight, and the results are shown in FIGS. 8(a) and 8(b) (for reference: when the K⁺ mole number is 1,000-fold higher than Cs⁺, the actual amount of contained K⁺ is 561 ppm, which is a condition similar to the K⁺ concentration in seawater, that is, 500 ppm).

In addition, the Sr²⁺ removal rate and distribution coefficient (k_{d}), in 20 mL of distilled water containing 1 ppm of Sr²⁺ and a competitive ion, Ca′, at an amount up to 10,000-fold higher than the Sr²⁺ mole number, were analyzed using 10 mg each of the sulfur (S)-zeolite (CHA) composites containing 10 wt % and 5 wt % of sulfur, on the basis of the total weight of the sulfur-zeolite composite and zeolite (CHA) on the basis of a zeolite weight, and the results are shown in FIGS. 8(c) and 8(d) (for reference: when the Ca²⁺ mole number is 1,000-fold higher than Sr²⁺, the actual amount of contained Ca²⁺ is 457 ppm, which is a condition similar to the Ca²⁺ concentration in seawater, that is, 500 ppm).

As shown in FIG. 8, it was confirmed that the higher the amount of sulfur added, the higher the Cs⁺ removal rate and distribution coefficient (Kd), and the lower the Sr²⁺ removal rate and distribution coefficient (K_{d}). According to the HSAB theory, since Cs, compared to a competitive ion, is a soft acid, it has a high chemical affinity with sulfur, which is a soft base, resulting in an increase in the Cs removal rate and distribution coefficient. On the other hand, since Sr is basically a hard acid, it has a low chemical affinity with sulfur, which is a soft base, it is determined that Sr does not easily have an ion exchange reaction with zeolite containing a large amount of sulfur.

For reference, under a seawater Cs⁺ condition (when K⁺ is 1,000-fold higher than the Cs⁺ mole number), it was confirmed that 5S-CHA has a removal rate and K_{d} similar to 10S-CHAR, and under a seawater Sr²⁺ condition (when Ca²⁺ is 1,000-fold higher than the Sr²⁺ mole number), it was confirmed that 5S-CHA has a removal rate and K_{d} similar to general CHA.

Judging from the above-described results collectively, for removal of a low concentration of Cs⁺ (Cs concentration of 1 ppm or less), zeolite containing a large amount of sulfur (S) is preferable, and for simultaneous removal of Sr²⁺ and Cs⁺, it is determined that a sulfur-zeolite composite (5S-Charbazite) containing 5 wt % of sulfur is the most preferable composition. This is because the above-mentioned examples exhibited a similar Cs⁺ removal performance to 10S-CHA under a seawater condition, and a similar Sr²⁺ removal performance to CHA under a seawater condition.

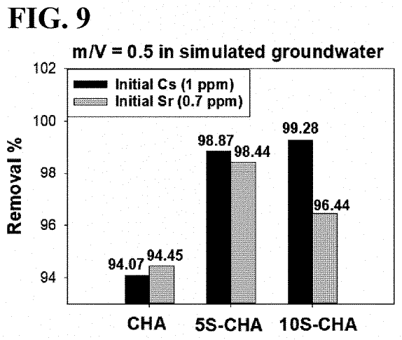

Subsequently, Cs⁺ and Sr²⁺ removal rates in 20 mL of groundwater containing 1 ppm of Cs⁺ and 0.7 ppm of Sr²⁺ were analyzed using 10 mg each of sulfur (S)-zeolite (CHA) composites containing 10 wt % and 5 wt % of sulfur on the basis of the total weight of sulfur-zeolite composite and zeolite (CHA) on the basis of a zeolite weight, and the results are shown in FIG. 9. As shown in FIG. 9, it was confirmed that, when 5 wt % of sulfur is contained (5 wt % of sulfur, 5S-CHA), it was confirmed that efficiency of simultaneous removal of Cs⁺ and Sr²⁺ is most excellent.

### Experimental Example 5: Changes in Adsorption Rate and Maximum Adsorption Amounts of Zeolites and Sulfur-Zeolite Composites

Using 10 mg each of sulfur (S)-zeolite (CHA) composites containing 10 wt % and 5 wt % of sulfur on the basis of the total weight of sulfur-zeolite composite and zeolite (CHA) on the basis of a zeolite weight, a change in Cs⁺ adsorption rate in 20 mL of distilled water containing 86 ppm of Cs⁺ and a change in Sr²⁺ adsorption rate in 20 mL of distilled water containing 98 ppm of Sr²⁺ were analyzed. It was shown that the higher the sulfur content, the lower the Cs⁺ adsorption rate (removal rate) and the Sr²⁺ adsorption rate. This is because sulfur occupies a pore of zeolite, and thus the direction in which Cs⁺ or Sr²⁺ passes is interfered with.

In addition, when more pores are occupied by sulfur, sites which Cs⁺ can enter are taken, and therefore, the maximum adsorption amount of Cs⁺ is lowered. However, as more pores are occupied by sulfur, it was confirmed that Langmuir constants (CHA: 1.78, 5S-CHA: 2.7, 10S-CHA: 6.16) increase (the slope increases), meaning that the chemical affinity with Cs⁺ is increased and thus the selectivity increases. When more pores are occupied by sulfur and sites which Sr²⁺ can enter are taken, it was confirmed that the maximum adsorption amount of Sr²⁺ is lowered, and Langmuir constants decrease (the slope decreases). This means that the affinity with Sr²⁺ was lowered.

### Experimental Example 6: Evaluation of Cesium Ion (Cs⁺) Removal Capability in the Presence of Competitive Ions for Zeolites and Sulfur-Zeolite Composites

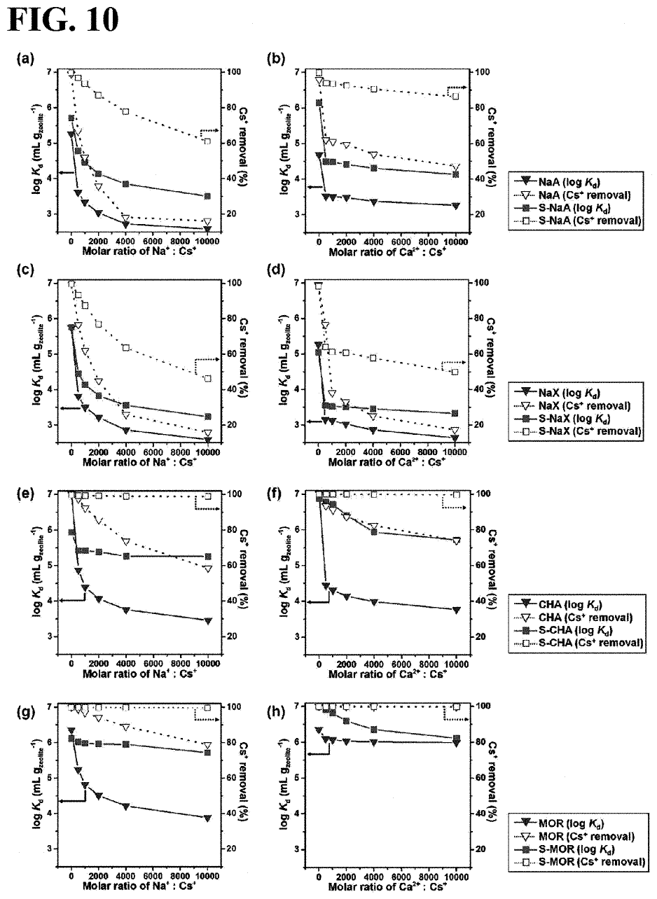

The cesium ion (Cs⁺) removal capability in an aqueous solution in the presence of competitive ions for the zeolites and sulfur-zeolite composites prepared in Example 1 was evaluated by an ion exchange method as follows. Distilled water containing 1 ppm of cesium ions (Cs⁺) was prepared, and then NaCl and CaCl₂.2H₂O were additionally dissolved therein to adjust a mole (number) ratio of competitive ions (Na⁺ or Ca²⁺) to cesium ions (Cs⁺) to 0 to 10,000-fold. An ion exchange experiment was performed by bringing 200 mL of the aqueous solution into contact with 0.1 g of zeolite and 0.111 g of a sulfur-zeolite composite at room temperature, and stirring the resulting mixture at 400 rpm for 3 hours. FIG. 10 is a set of graphs showing Cs⁺ distribution coefficients (K_{d}, mL g_{zeolite}⁻¹) and ion removal rates (Cs⁺ removal, %) when zeolites and sulfur-zeolite composites are brought into contact with a 1 ppm Cs⁺ solution containing sodium (Na⁺) and calcium (Ca²⁺) as competitive ions. As shown in FIG. 10, as the concentrations of competitive ions such as sodium (Na⁺) and calcium (Ca²⁺) increase, all adsorbents are decreased in Cs⁺ distribution coefficient (K_{d}, mL g_{zeolite}⁻¹) and removal rate (removal, %). This means that the presence of the competitive ions such as sodium (Na⁺) and calcium (Ca²⁺) has an adverse effect on the radionuclide ion exchange of zeolite and a sulfur-zeolite composite. However, regardless of the concentration of competitive ions, all sulfur-zeolite composites exhibit much higher distribution coefficients and ion removal rates than the corresponding zeolites, demonstrating that a sulfur-zeolite composite has higher radionuclide selectivity than a corresponding zeolite.

A radionuclide absorbent of the present invention can more selectively remove radioactive cesium (Cs⁺) and/or strontium (Sr²⁺) ions in the presence of various competitive ions (e.g., Na⁺, K⁺, Mg²⁺ and Ca²⁺) in groundwater or seawater, compared to conventional zeolite.

In addition, the radionuclide absorbent of the present invention can be prepared by a simple method of thermally treating a mixture of sulfur and zeolite, and according to the above-described method, sulfur can be uniformly dispersed in zeolite.

It should be understood by those of ordinary skill in the art that the above description of the present invention is exemplary, and the exemplary embodiments disclosed herein can be easily modified into other specific forms without departing from the technical spirit or essential features of the present invention. Therefore, the exemplary embodiments described above should be interpreted as illustrative and not limited in any aspect.

What is claimed is:

1. A radionuclide absorbent comprising a sulfur-zeolite composite in which sulfur is dispersed in zeolite.

2. The radionuclide absorbent of claim 1, wherein the sulfur-zeolite composite comprises 1 to 25 wt % of sulfur on the basis of the total weight of the composite.

3. The radionuclide absorbent of claim 1, wherein the sulfur-zeolite composite comprises 3 to 20 wt % of sulfur on the basis of the total weight of the composite.

4. The radionuclide absorbent of claim 1, wherein the sulfur-zeolite composite comprises 4 to 12 wt % of sulfur on the basis of the total weight of the composite.

5. The radionuclide absorbent of claim 1, wherein the zeolite is one selected from the group consisting of chabazite (CHA), mordenite (MOR), NaA, NaX, faujasite (FAU), Linde Type A (LTA), analcime (ANA), Linde Type L (LTL), EMT (EMC-2), MFI (ZSM-5), ferrierite (FER), heulandite (HEU), beta polymorph A (BEA) and MTW (ZSM-12) structures, or a combination thereof.

6. The radionuclide absorbent of claim 1, wherein the radionuclide comprises one or more selected from cesium or strontium.

7. The radionuclide absorbent of claim 1, wherein the sulfur-zeolite composite comprises 1 to 25 wt % of sulfur on the basis of the total weight of the composite, and the radionuclide is cesium.

8. The radionuclide absorbent of claim 1, wherein the zeolite is NaX.

9. The radionuclide absorbent of claim 1, wherein the sulfur-zeolite composite comprises 4 to 12 wt % of sulfur on the basis of the total weight of the composite, and the radionuclide is cesium and strontium.

10. The radionuclide absorbent of claim 9, wherein the zeolite is chabazite (CHA).

11. The radionuclide absorbent of claim 1, wherein the composite is prepared by sublimating sulfur through thermal treatment of a mixture of sulfur and zeolite.

12. A method of preparing a radionuclide absorbent by thermally treating a mixture of sulfur and zeolite.

13. The method of claim 12, wherein the thermal treatment temperature ranges from 50 to 700° C.

14. The method of ºlaim 12, wherein the mixture is prepared by mixing 1 to 25 wt % of sulfur on the basis of the total weight of the mixture.

15. A method of removing a radionuclide, comprising:
adsorbing a radionuclide by bringing a radionuclide absorbent including a sulfur-zeolite composite in which sulfur is dispersed in zeolite into contact with a solution containing cesium or strontium ions.
